(19) United States
(12) Patent Application Publication
(10) Pub. No.: US 2023/0307763 A1
(43) Pub. Date: Sep. 28, 2023

(54) METHODS FOR ASSEMBLING TRACTION BATTERY PACKS THAT INCLUDE CELL-TO-PACK BATTERY SYSTEMS

(71) Applicant: FORD GLOBAL TECHNOLOGIES, LLC, Dearborn, MI (US)

(72) Inventors: Patrick Daniel MAGUIRE, Ann Arbor, MI (US); Che-Chun CHANG, Ann Arbor, MI (US); Marc DUGAS, Wixom, MI (US)

(21) Appl. No.: 17/894,327

(22) Filed: Aug. 24, 2022

Related U.S. Application Data
(60) Provisional application No. 63/322,766, filed on Mar. 23, 2022.

(51) Int. Cl. H01M 50/249; H01M 50/204

(52) U.S. Cl. CPC H01M 50/249; H01M 50/204; H01M 2220/20

(57) ABSTRACT

Manufacturing processes are disclosed for assembling traction battery packs that include cell-to-pack battery systems. An exemplary assembly method includes inserting a cell matrix of the cell-to-pack battery system into a cell-compressing opening of an enclosure tray using a top-down approach. The method may include compressing a plurality of cell stacks to a desired length, compressing the cell stacks together in a transverse direction to form the cell matrix, and then installing the cell matrix as a single unit into the cell-compressing opening of the enclosure tray.

### CROSS-REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs, and more particularly to methods for assembling traction battery packs that include cell-to-pack battery systems.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A method for assembling a traction battery pack according to an exemplary aspect of the present disclosure includes, among other things, assembling a plurality of cell stacks, arranging the plurality of cell stacks side-by-side to provide a cell matrix, and inserting the cell matrix into a cell-compressing opening of an enclosure tray of the traction battery pack.

In a further non-limiting embodiment of the foregoing method, the cell matrix is part of a cell-to-pack battery system of the traction battery pack.

In a further non-limiting embodiment of either of the foregoing methods, after the inserting, the method includes applying a compressive force to the cell matrix via the cell-compressing opening.

In a further non-limiting embodiment of any of the foregoing methods, assembling the plurality of cell stacks includes staging each of the plurality of cell stacks within its own compression fixture.

In a further non-limiting embodiment of any of the foregoing methods, assembling the plurality of cell stacks includes compressing a first cell stack of the plurality of cell stacks within a first compression fixture and compressing a second cell stack of the plurality of cell stacks within a second compression fixture.

In a further non-limiting embodiment of any of the foregoing methods, arranging the plurality of cell stacks side-by-side includes pressing the first cell stack relatively toward the second cell stack such that the first compression fixture contacts the second compression fixture.

In a further non-limiting embodiment of any of the foregoing methods, inserting the cell matrix into the cell-compressing opening includes applying a downward force to the cell matrix to move the cell matrix into the enclosure tray.

In a further non-limiting embodiment of any of the foregoing methods, prior to the inserting, the method includes pressing the plurality of cell stacks together until adjacent compression fixtures of the plurality of cell stacks contact one another.

In a further non-limiting embodiment of any of the foregoing methods, during the arranging, the method includes applying a compressive force to the plurality of cell stacks with a cell matrix joiner assembly.

In a further non-limiting embodiment of any of the foregoing methods, during the assembling, the method includes applying a first compressive force to each of the plurality of cell stacks. During the arranging, the method includes applying a second compressive force to press the plurality of cell stacks relatively toward one another.

In a further non-limiting embodiment of any of the foregoing methods, the second compressive force is applied transversely to the first compressive force.

In a further non-limiting embodiment of any of the foregoing methods, during the inserting, the method includes applying a downward force to the cell matrix.

In a further non-limiting embodiment of any of the foregoing methods, the downward force is applied transversely to each of the first compressive force and the second compressive force.

A method for assembling a traction battery pack according to another exemplary aspect of the present disclosure includes, among other things, using a top-down approach, inserting a cell matrix of a cell-to-pack battery system into a cell-compressing opening of an enclosure tray of the traction battery pack.

In a further non-limiting embodiment of the foregoing method. prior to the inserting, the method includes applying a first compressive force to compress a first cell stack of the cell matrix to a first desired length, and applying a second, first compressive force to compress a second cell stack of the cell matrix to a second desired length.

In a further non-limiting embodiment of either of the foregoing methods, the method includes arranging the first cell stack and the second cell stack side-by-side to one another while maintaining the first compressive force and the second, first compressive force.

In a further non-limiting embodiment of any of the foregoing methods, the method includes applying a second compressive force to compress the first cell stack and the second cell stack together.

In a further non-limiting embodiment of any of the foregoing methods, the second compressive force is a smaller force than the first compressive force or the second, first compressive force.

In a further non-limiting embodiment of any of the foregoing methods, the inserting includes applying a downward force to move the cell matrix into the enclosure tray.

In a further non-limiting embodiment of any of the foregoing methods, the downward force is applied transversely to each of the first compressive force, the second, first compressive force, and the second compressive force.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 is a partially exploded view of another traction battery pack having a cell-to-pack battery system.

FIGS. 5, 6, and 7 schematically illustrate a method of assembling a traction battery pack that includes a cell-to-pack battery system.

### DETAILED DESCRIPTION

This disclosure details manufacturing processes for assembling traction battery packs that include cell-to-pack battery systems. An exemplary assembly method includes inserting a cell matrix of the cell-to-pack battery system into a cell-compressing opening of an enclosure tray using a top-down approach. The method may include compressing a plurality of cell stacks to a desired length, compressing the cell stacks together in a transverse direction to form the cell matrix, and then installing the cell matrix as a single unit into the cell-compressing opening of the enclosure tray. These and other features are discussed in greater detail in the following paragraphs of this detailed description.

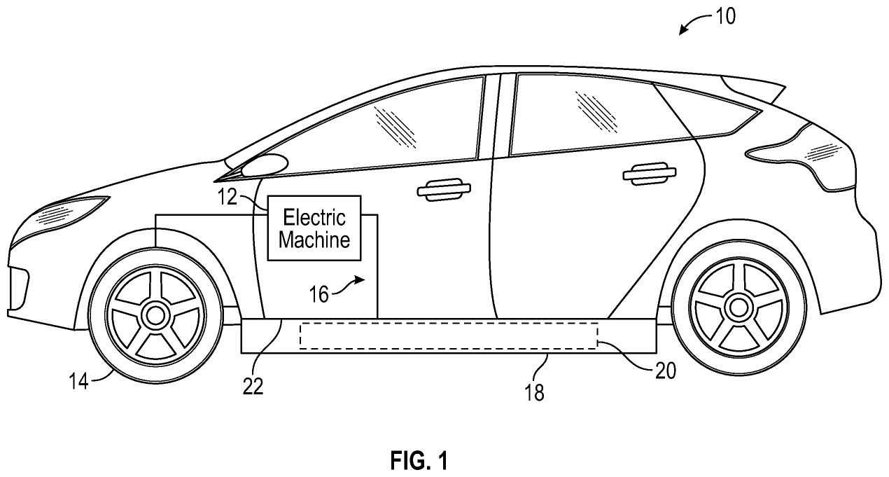

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules inside the batter enclosure. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

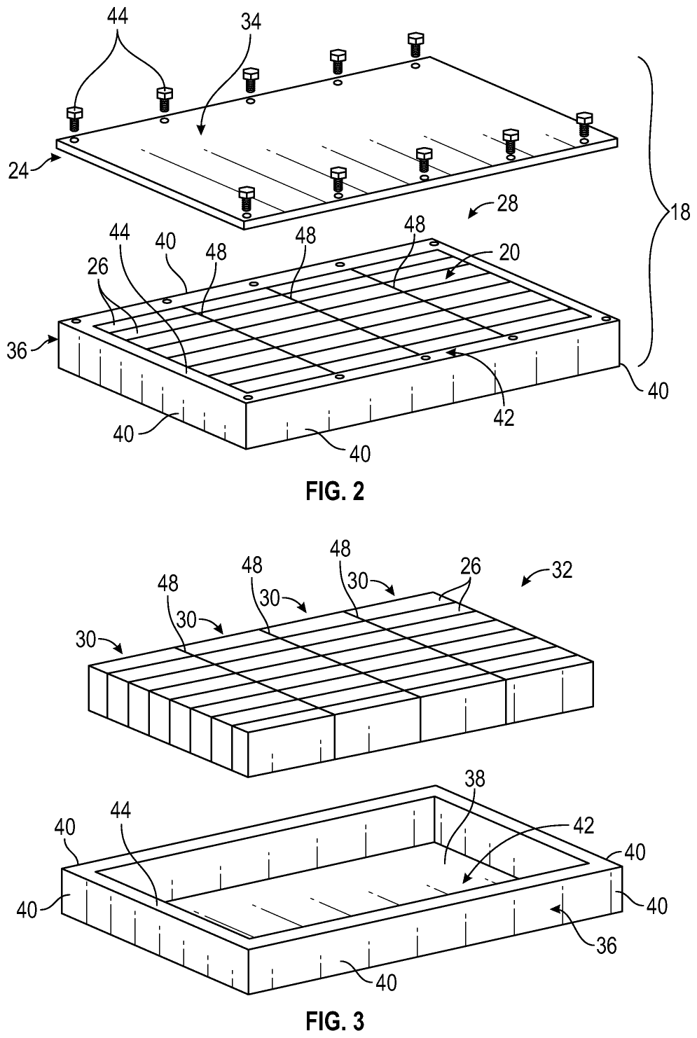

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

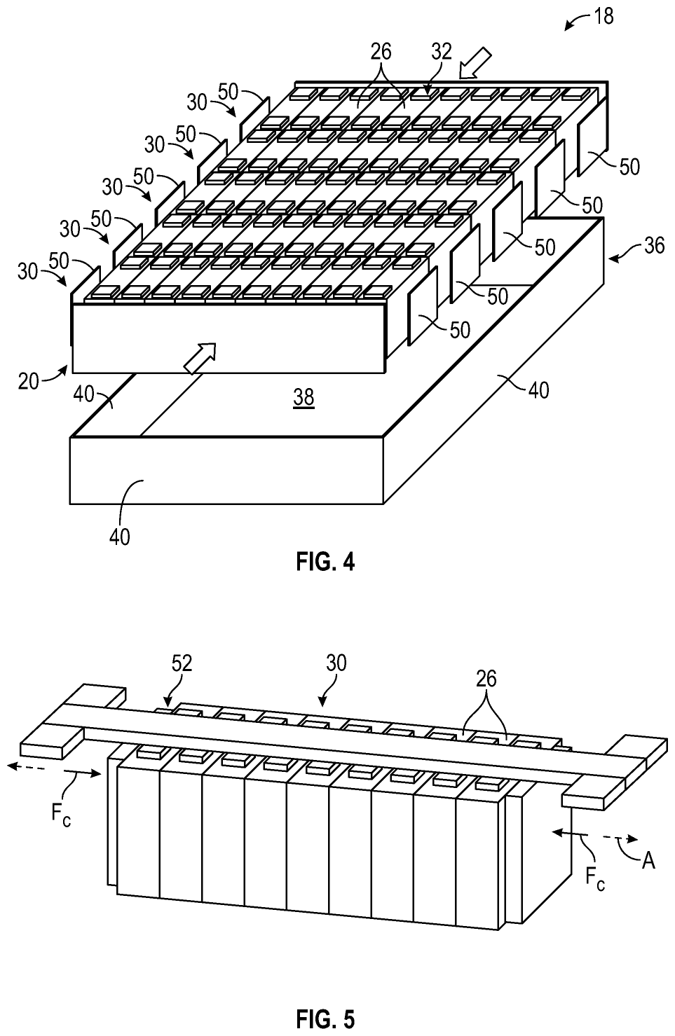

In an embodiment, each cell stack 30 includes eight individual battery cells 26, and the cell matrix 32 includes four cell stacks 30 for a total of thirty-two battery cells 26. In another embodiment, each cell stack 30 includes ten individual battery cells 26, and the cell matrix 32 includes five cell stacks 30 for a total of fifty battery cells 26 (see FIG. 4). Providing an even quantity of battery cells 26 and an even quantity of cell stacks 30 can help to support an efficient electrical bussing arrangement. Although a specific number of battery cells 26 and cells stacks 30 are illustrated in various figures of this disclosure, the cell-to-pack battery system 20 of the traction battery pack 18 could include any number of battery cells 26 and any number of cell stacks 30. In other words, this disclosure is not limited to the exemplary configurations shown in FIGS. 2, 3, and 4.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply compressive forces to the cell matrix 32 when the cell matrix 32 is positioned within the cell-compressing opening 42. An entire perimeter of the cell-compressing opening 42 may be established by the side walls 40 of the enclosure tray 36. The side walls 40 can apply the compressive forces to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include outer enclosures holding arrays of battery cells enclosed by array support structures that are spaced apart from walls of the battery enclosure, and where the outer enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure.

The cell-to-pack battery system 20 may further include one or more shims 50 (see embodiment of FIG. 4). The shims 50 may compensate for tolerance variations in the side walls 40 of the enclosure tray 36. The shims 50 may be positioned between each cell stack 30 and the enclosure tray 36, with one shim 50 being located at each longitudinal extent of the cell stack 30. The shims 50 may be positioned relative to the cell stacks 30 either before or after inserting the cell matrix 32 into the cell-compressing opening 42.

FIGS. 5-9, with continued reference to FIGS. 1-4, schematically illustrates a method for assembling portions of the traction battery pack 18. The method may include a greater or fewer number of steps than recited below, and the exact order of the steps is not intended to limit this disclosure.

Referring first to FIG. 5, each cell stack 30 of the cell-to-pack battery system 20 may first be staged by positioning a group of battery cells 26 within a compression fixture 52. The compression fixture 52 may provide a reference point relative to at least two adjacent sides of the cell stack 30 (e.g., bottom and end). The battery cells 26 may be compressed along a cell stack axis A to provide one of the cell stacks 30. The compression fixture 52 may exert a compressive force F_{C} along the cell stack axis A to opposed ends of the cell stack 30. The compressive force F_{C} essentially squeezes the battery cells 26 within the cell stack 30, thereby compressing the cell stack 30 and the individual battery cells 26 to a desired cell stack length.

In an embodiment, the compressive force F_{C} exerted on the battery cells 26 by the compression fixture 52 is about 3 kilonewtons. However, the actual compression force applied can vary depending on the battery cell type, among other factors. In this disclosure, the term “about” means that the expressed quantities or ranges need not be exact but may be approximated and/or larger or smaller, reflecting acceptable tolerances, conversion factors, measurement error, etc.

The compression fixture 52 could be driven by a pneumatic actuator to compress the battery cells 26 along the cell stack axis A. However, other types of actuators, such as a DC electrical or a mechanical screw actuator, could alternatively be employed for achieving the compression.

In an exemplary method, the method step schematically illustrated in FIG. 5 is performed four times to provide the four cell stacks 30 of the cell-to-pack battery system 20. Each of the cell stacks 30 is compressed and held by a different compression fixture that mimics the compression fixture 52. Thus, in this exemplary embodiment, four compression fixtures 52 would be used to provide the four cell stacks 30 of the exemplary cell-to-pack battery system 20.

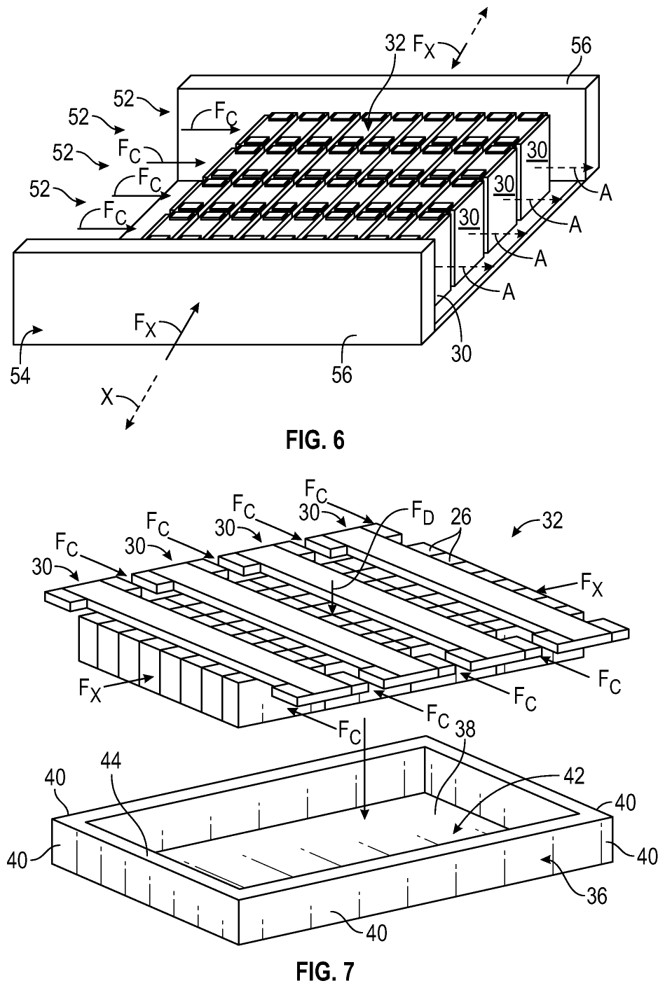

Next, as shown in FIG. 6, the cell stacks 30 may be positioned side-by-side to one another while the compression forces F_{C} are maintained by the compression fixtures 52 to establish the cell matrix 32. Within the cell matrix 32, the cell stack axes A are parallel to each other. A cell matrix joiner assembly 54 may then apply additional compressive forces F_{X} to compress the cell stacks 30 together along a joiner axis X. The compressive forces F_{X} are transverse (e.g., about perpendicular) to the compressive forces F_{C}. In an embodiment, the compressive forces F_{C} are generally larger compressive forces than the compressive forces F_{X}.

The cell matrix joiner assembly 54 may include a pair of platen 56, with one platen arranged for applying the compressive force F_{X} on each opposing side of the cell matrix 32. The cell matrix joiner assembly 54 may be moved by an actuator along the joiner axis X to press the cell stacks 30 together along the joiner axis X. When the traction battery pack 18 is installed within the vehicle, the joiner axis X corresponds to a longitudinal axis of the electrified vehicle 10.

In an embodiment, the cell matrix joiner assembly 54 presses the cell stacks 30 along the joiner axis X until the compression fixtures 52 contact each other, which prevents the battery cells 26 in one of the cell stacks 30 from directly contacting the battery cells 26 of adjacent cell stacks 30. Contact between the compression fixtures 52 can help locate the cell stacks 30 relative to one another.

Referring now to FIG. 7, the cell matrix 32 may be next be positioned vertically above the enclosure tray 36 with the floor 38 facing upwardly toward the cell matrix 32. As schematically illustrated, the compressive forces F_{C} and F_{X} may be maintained by the compressive fixture 52 and the cell matrix joiner assembly 54 during the positioning of the cell matrix 32.

Using a top-down approach, the cell matrix 32 may then be inserted into the cell-compressing opening 42 of the enclosure tray 36 by exerting a downward force F_{D}. The cell stacks 30 are therefore inserted into the enclosure tray 36 simultaneously and as a single unit rather than individually. The downward force F_{D} may be applied directly to one or more battery cells 26 of one or more cell stacks 30 of the cell matrix 32. The downward force F_{D} is applied in a direction that is generally perpendicular to both the compressive forces F_{C} and the compressive force F_{X}. The downward force F_{D} may be provided by yet another actuator.

While the term “downward” is used herein to describe the downward force F_{D}, it should be understood that the term “downward” is used herein to refer to forces tending to press a cell stack 30 into the cell-compressing opening 42. In particular, the term “downward” refers to all forces substantially perpendicular to the compressive force F_{C}, whether or not the force is truly in a “downward” direction. For example, this disclosure extends to cell stacks that are compressed and inserted into a cell-compressing opening in a sideways direction.

After the inserting, the cell-compressing opening 42 of the enclosure tray 36 circumferentially surrounds the cell matrix 32 (see FIG. 2). The cell-compressing opening 42 may thus exert a compressive force on each of the cell stacks 30. The cell-compressing opening 42 may permit some expansion of the battery cells 26 after they are removed from the compression fixtures 52. The compressive forces exerted on the cell stacks 30 by the enclosure tray 36 after the inserting may be less than the compressive forces F_{c} exerted on the cell stacks 30 by the compression fixtures 52.

The exemplary manufacturing processes described herein provide a methodology for assembling traction battery packs that include cell-to-pack battery systems. The battery cells of the cell-to-pack battery system may advantageously be installed as a single unit using a top-down approach with the enclosure floor facing up as part of the proposed methodology, thereby providing solutions to various assembly complexities that can arise as a result of eliminating much of the array support structures associated with conventional traction battery packs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method for assembling a traction battery pack, comprising:
assembling a plurality of cell stacks;
arranging the plurality of cell stacks side-by-side to provide a cell matrix; and
inserting the cell matrix into a cell-compressing opening of an enclosure tray of the traction battery pack.

2. The method as recited in claim 1, wherein the cell matrix is part of a cell-to-pack battery system of the traction battery pack.

3. The method as recited in claim 1, comprising, after the inserting, applying a compressive force to the cell matrix via the cell-compressing opening.

4. The method as recited in claim 1, wherein assembling the plurality of cell stacks includes:
staging each of the plurality of cell stacks within its own compression fixture.

5. The method as recited in claim 1, wherein assembling the plurality of cell stacks includes:
compressing a first cell stack of the plurality of cell stacks within a first compression fixture; and
compressing a second cell stack of the plurality of cell stacks within a second compression fixture.

6. The method as recited in claim 5, wherein arranging the plurality of cell stacks side-by-side includes:
pressing the first cell stack relatively toward the second cell stack such that the first compression fixture contacts the second compression fixture.

7. The method as recited in claim 6, wherein inserting the cell matrix into the cell-compressing opening includes:
applying a downward force to the cell matrix to move the cell matrix into the enclosure tray.

8. The method as recited in claim 1, comprising, prior to the inserting, pressing the plurality of cell stacks together until adjacent compression fixtures of the plurality of cell stacks contact one another.

9. The method as recited in claim 8, wherein, during the arranging, applying a compressive force to the plurality of cell stacks with a cell matrix joiner assembly.

10. The method as recited in claim 1, comprising:
during the assembling, applying a first compressive force to each of the plurality of cell stacks; and
during the arranging, applying a second compressive force to press the plurality of cell stacks relatively toward one another.

11. The method as recited in claim 10, wherein the second compressive force is applied transversely to the first compressive force.

12. The method as recited in claim 10, comprising:
during the inserting, applying a downward force to the cell matrix.

13. The method as recited in claim 12, wherein the downward force is applied transversely to each of the first compressive force and the second compressive force.

14. A method for assembling a traction battery pack, comprising:
using a top-down approach, inserting a cell matrix of a cell-to-pack battery system into a cell-compressing opening of an enclosure tray of the traction battery pack.

15. The method as recited in claim 14, comprising, prior to the inserting:
applying a first compressive force to compress a first cell stack of the cell matrix to a first desired length; and
applying a second, first compressive force to compress a second cell stack of the cell matrix to a second desired length.

16. The method as recited in claim 15, comprising:
arranging the first cell stack and the second cell stack side-by-side to one another while maintaining the first compressive force and the second, first compressive force.

17. The method as recited in claim 16, comprising:
applying a second compressive force to compress the first cell stack and the second cell stack together.

18. The method as recited in claim 17, wherein the second compressive force is a smaller force than the first compressive force or the second, first compressive force.

19. The method as recited in claim 16, wherein the inserting includes:
applying a downward force to move the cell matrix into the enclosure tray, wherein the downward force is applied transversely to each of the first compressive force, the second, first compressive force, and the second compressive force.

20. A method for assembling a traction battery pack, comprising:
arranging a plurality of cell stacks side-by-side to provide a cell matrix; and
inserting the cell matrix into a cell-compressing opening of an enclosure tray of the traction battery pack.
